(19) United States
(12) Patent Application Publication
(10) Pub. No.: US 2009/0059076 A1
(43) Pub. Date: Mar. 5, 2009

(54) GENERATING DEVICE FOR SEQUENTIAL INTERLACED SCENES

(76) Inventor: Che-Sheng Yu, XiZhi City (TW)

Correspondence Address: ANTHONY R. BARKUME, 20 GATEWAY LANE, MANORVILLE, NY, 11949, US

(21) Appl. No.: 12/198,198

(22) Filed: Aug. 26, 2008

(30) Foreign Application Priority Data
Aug. 29, 2007 (TW) 096132164

(51) Int. Cl. H04N 9/74

(52) U.S. Cl. 348/584; 348/E09.055

(57) ABSTRACT

The present invention relates to a generating device for sequential interlaced scenes comprising: an interlaced scene generating unit; a video signal input unit, which electrically connects with the interlaced scene generating unit, for receiving a first scene video signal and a second scene video signal, and transferring the first scene video signal and the second scene video signal to the interlaced scene generating unit; wherein the interlaced scene generating unit is able to generate an interlaced scene video signal, and the interlaced scene video signal is combined by the first scene video signal and the second scene video signal in interlacing and by time.

### FIELD OF THE INVENTION

The present invention relates to a generating device for sequential interlaced scenes, especially to combine multiple scene video signals as an interlaced scene video signal by time in the generating device.

### BACKGROUND OF THE INVENTION

The traditional cameras are able to transfer captured video images to the display devices for showing out through the transmission lines. Newer generation's traditional cameras even comprise built-in web server features, to allow users who would like to see captured video images be able to see them anywhere immediatelly and very conveniently through the internet connection with the web servers in the network cameras, without any external machines or connection line layout.

If using the traditional cameras or network cameras, users need to set up a camera with transmission line and power line or a network camera with network cable or power line for every scene respectively for seeing the video image of every scene, and if the video images that captured by every camera are independent video signals and need to be transferred individually, so, if users need to show out all the scenes' images when transferring these signals to the computers, the processes of synchronization of scenes images, switching of scenes images, or rotating playing back for scenes images by software applications are required and this way is very inconvenient. Further more, the hackers only need to get the video signals from the transmission lines or through the networks if they hacker into the systems. Every video signal of respective scene needs to transfer some extra controlling signals during transferring, which wastes the transmission media bandwidth for individual transmission.

There are several disadvantages in the technologies of traditional camera devices:

1. In the application of using traditional camera devices into the multiple scene video images viewing, software application is required with worse performance.

2. In the application of using traditional camera devices into the multiple scene video images viewing, multiple scene video images have to be transferred individually, and the content of video signals are easy to be hacked by hackers with worse secure.

3. In the application of using traditional camera devices into the multiple scene video images viewing, every video signal of respective scene needs to transfer some extra controlling signals during transferring, which wastes the transmission media bandwidth for individual transmission.

Therefore, how to improve the above traditional disadvantages to allow multiple scene video signals can be combined as an interlaced scene video signal by time and interlaced, is the major topic of the present invention.

### SUMMARY OF THE INVENTION

The objective of the present invention is to provide a new and advanced generating device for sequential interlaced scenes, which uses a video signal input unit to transfer video signals of different scenes to one interlaced scene generating unit, and to let this interlaced scene generating unit process the generation of combining above video signals of different scenes by time and interlaced to get one interlaced scene video signal.

According to the present invention, a generating device for sequential interlaced scenes comprising: an interlaced scene generating unit; a video signal input unit, which electrically connects with the interlaced scene generating unit, for receiving a first scene video signal and a second scene video signal, and transferring the first scene video signal and the second scene video signal to the interlaced scene generating unit; wherein the interlaced scene generating unit is able to generate an interlaced scene video signal, and the interlaced scene video signal is combined by the first scene video signal and the second scene video signal in interlacing and by time.

In accordance with one aspect of the present invention, the interlaced scene video signal can be combined by more scene video signals in interlacing and by time.

In accordance with one aspect of the present invention, the first scene video signal and the second scene video signal are from a rotating lens camera.

In accordance with one aspect of the present invention, the video signal input unit electrically connects with a first camera and a second camera, and the first camera is able to generate the first scene video signal, the second camera is able to generate the second scene video camera, respectively.

In accordance with one aspect of the present invention, the video signal input unit is a screen, and this screen is able to switch to any one of the multiple projection devices for receiving its video signals.

In accordance with one aspect of the present invention, a sequential interlaced scene separating device is connected for recovering the interlaced scene video signal back to the first scene video signal and the second scene video signal.

In accordance with one aspect of the present invention, the frame rate of the interlaced scene video signal is higher than those of the first scene video signal and the second scene video signal.

The present invention may best be understood through the following description with reference to the accompanying drawing patterns, in which:

### BRIEF DESCRIPTION OF THE DRAWING PATTERNS

FIG. 1 shows the structure diagram of the generating device according to the present invention for sequential interlaced scenes;

FIG. 2 shows the structure diagram of the generating device according to the present invention for sequential interlaced scenes, which is implemented by multiple cameras;

FIG. 3 shows the structure diagram of the generating device according to the present invention for sequential interlaced scenes, which is implemented by multiple projection devices;

FIG. 4 shows the structure diagram of the generating device according to the present invention for sequential interlaced scenes, which is implemented by multiple rotating lense cameras;

FIG. 5 shows the structure diagram of the sequential interlaced scene generating device combining with the sequential interlaced scene separating device according to the present invention.

### DETAILED DESCRIPTION OF THE PREFERRED EMBODIMENT

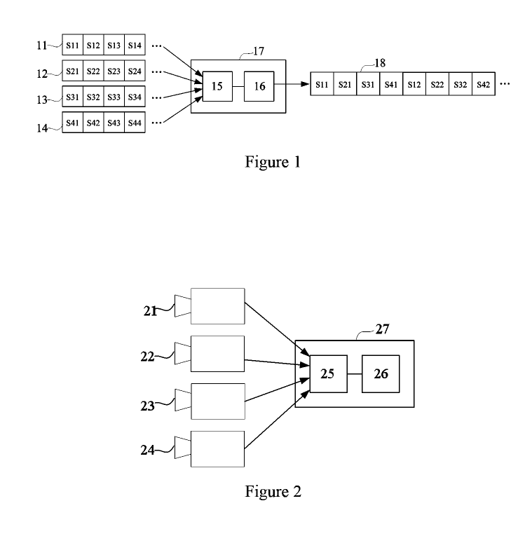

FIG. 1 shows the structure diagram of the generating device according to the present invention for sequential interlaced scenes, which comprises one first scene video signal 11, one second scene video signal 12, one third scene video signal 13, one fourth scene video signal 14, one video signal input unit 15, one interlaced scene generating unit 16, one sequential interlaced scene generating device 17, and one interlaced scene video signal 18.

In the present invention, the sequential interlaced scene generating device 17 comprises one video signal input unit 15 and one interlaced scene generating unit 16. All the first scene video signal 11, the second scene video signal 12, the third scene video signal 13, and the fourth scene video signal 14 input to the video signal input unit 15, and be transferred to the interlaced scene generating unit 16 by the video signal input unit 15. After receiving the video signals of different scenes, the interlaced scene generating unit 16 will process the interlaced combination for different scene video signals by time, for example, combining the video image (S11) of the first scene video signal 11 in the first time, the video image (S21) of the second scene video signal 12 in the second time, the video image (S31) of the third scene video signal 13 in the third time, and the video image (S41) of the fourth scene video signal 14 in interlaced as an assembled video signal (S11, S21, S31, S41, S12, S22, . . . ), and finally becomes an interlaced scene video signal 18.

FIG. 2 shows the structure diagram of the generating device according to the present invention for sequential interlaced scenes, which uses multiple cameras and comprises one first scene camera 21, one second scene camera 22, one third scene camera 23, one fourth scene camera 24, one video signal input unit 25, one interlaced scene generating unit 26, and one sequential interlaced scenes generating device 27.

In accordance with the generating device of sequential interlaced scene separating device 27 of the present invention, the video signal of every scene that is input to the video signal input unit 25 can be provided by multiple cameras set up in the different scenes, and connects the first scene camera 21, the second scene camera 22, the third scene camera 23, and the fourth scene camera 24 with the video signal input unit 25, to make the video images that are captured by the cameras of the four scenes be able to input to the video signal input unit 25, and then be transferred to the interlaced scene generating unit 26 by the video signal input unit 25, for video interlaced assembling process.

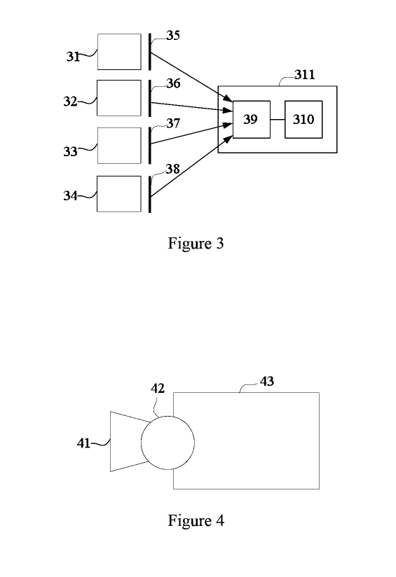

FIG. 3 shows the structure diagram of the generating device according to the present invention for sequential interlaced scenes, which uses multiple projection devices and comprises one first scene projection device 31, one second scene projection device 32, one third scene projection device 33, one fourth scene projection device 34, one first scene control device 35, one second scene control device 36, one third scene control device 37, one fourth scene control device 38, one video signal input unit 39, one interlaced scene generating unit 310, and one sequential interlaced scenes generating device 311.

In accordance with the sequential interlaced scenes generating device 311 of the present invention, it also can be implemented by multiple projection devices of different scenes, which projects the projection images from the first scene projection device 31, the second scene projection device 32, the third scene projection device 33, and the fourth scene projection device 34 to the video signal input unit 39, in which the video signal input unit 39 can be a screen for receiving projection images; and then, the interlaced scene generating unit 310 is able to control and switch the first scene control device 35, the second scene control device 36, the third scene control device 37, and the fourth scene control device 38, to make only one projection device project out in one time, and generate the interlaced scene video signals by switching each control device.

FIG. 4 shows the structure diagram of the rotating lense camera according to the present invention for sequential interlaced scenes generating device, which comprises one lense 41, rotating device 42, and camera 43.

In accordance with the sequential interlaced scenes generating device of the present invention, it also can be implemented by a rotating lense camera, which uses the rotating device 42 in the camera 43, such as a step motor, to control the lense 41 for rotating to capture different video images of different scenes, and to transfer back to camera 43 for generating the interlaced scene video signals.

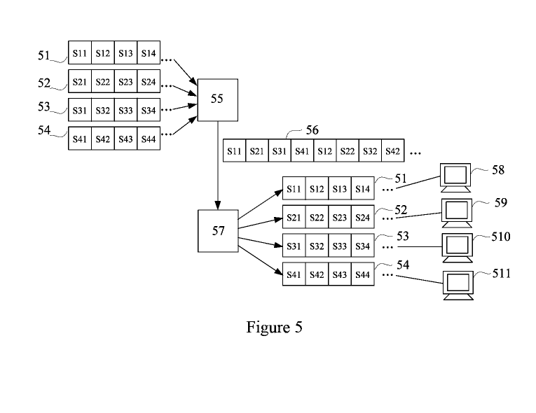

FIG. 5 shows the structure diagram of combining the sequential interlaced scenes generating device and the sequential interlaced scene separating device according to the present invention, which comprises one first scene video signal 51, one second scene video signal 52, one third scene video signal 53, one fourth scene video signal 54, one sequential interlaced scenes generating device 55, one interlaced scene video signal 56, one sequential interlaced scene separating device 57, one first scene display device 58, one second scene display device 59, one third scene display device 510, and one fourth scene display device 511.

In accordance with the generating device of sequential interlaced scene separating device 55 of the present invention, the interlaced scene video signal 56 can be separated and reduced to multiple scene video signals by connecting with the sequential interlaced scene separating device 57. In accordance with FIG. 5, the sequential first scene video signal 51 (S11, S12, . . . ), the second scene video signal 52 (S21, S22, . . . ), the third scene video signal 53 (S31, S32, . . . ), and the fourth scene video signal 54 (S41, S42, . . . ) are input to the sequential interlaced scenes generating device 55 respectively, and this sequential interlaced scenes generating device 55 will start the interlaced combination for the video signals of these four scenes by time, to generate one interlaced scene video signal 56 (S11, S21, S31, S41, S12, S22, . . . ), to transfer this interlaced scene video signal 56 to the sequential interlaced scene separating device 57, and this sequential scenes separating device 57 will separate interlaced scene video signal 56 to recover as original sequential first scene video signal 51 (S11, S12, . . . ), the second scene video signal 52 (S21, S22, . . . ), the third scene video signal 53 (S31, S32, . . . ), and the fourth scene video signal 54 (S41, S42, . . . ) by time after receiving this interlaced scene video signal 56, and to transfer to the first scene display device 58, the second scene display device 59, the third scene display device 510, and the fourth scene display device 511 for showing out, respectively. Of course, we may use direct transferring by electrical signal between the sequential interlaced scenes generating device 55 and sequential interlaced scene separating device 57, or by optical signal solution, and there is a synchronization mechanism between above two devices for making sure they are able to work well.

In real operations, the video transmission rate of the first scene video signal 51 (S11, S12, S13, S14), the second scene video signal 52 (S21, S22, S23, S24), the third scene video signal 53 (S31, S32, S33, S34), and the fourth scene video signal 54 (S41, S42, S43, S44) can be 30 F/S (Frame per second), but the video transmission rate of interlaced scene video signal 56 (S11, S21, S31, S41, S12, S22, S32, S42, . . . ) can be 120 F/S (Frame per second).

There are several advantages in the present invention:

1. In accordance with the generating device for sequential interlaced scenes of the present invention, multiple video signals of different scenes can be combined as an interlaced scene video signal, to save the bandwidth of control signals during the transmission;

2. In accordance with the generating device for sequential interlaced scenes of the present invention, the video signals of multiple scenes can be interlaced combined by specific timing rule, to encode the combined interlaced video signal for security enhancement;

3. In accordance with the generating device for sequential interlaced scenes of the present invention, which is able to transmit the combined interlaced video signals from multiple scenes, and to recover it back to original multiple scene video signals by a sequential interlaced scene separating device.

To sum up, the generating device for sequential interlaced scenes of the present invention uses one video signal input unit to receive different video signals from different scenes, transfers these different scene video signals to one interlaced scene generating unit, and starts the interlaced combination process for the received different scene video signals by time, in order to generate one interlaced scene video signal, which is an advanced, new, and practical. All the design changes that based on the theory of the present invention, just likes the different types of video signal input units, different types of interlaced scene generating units, or different devices to provide interlaced scene video signals, are covered by the present invention if any architecture used one video signal input unit to receive multiple video signals of scenes, transferred to an interlaced scene generating unit to process the interlaced combination by time, and was able to generate an interlaced scene video signal.

While the invention has been described in terms of what are presently considered to be the most practical and preferred embodiments, it is to be understood that the invention need not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A generating device for sequential interlaced scenes comprising:
an interlaced scene generating unit;
a video signal input unit, which electrically connects with the interlaced scene generating unit, for receiving a first scene video signal and a second scene video signal, and transferring the first scene video signal and the second scene video signal to the interlaced scene generating unit;
wherein the interlaced scene generating unit is able to generate an interlaced scene video signal, and the interlaced scene video signal is combined by the first scene video signal and the second scene video signal in interlacing and by time.

2. A device according to claim 1, wherein the interlaced scene video signal can be combined by more scene video signals in interlacing and by time.

3. A device according to claim 1, wherein the first scene video signal and the second scene video signal are from a rotating lens camera.

4. A device according to claim 1, wherein the video signal input unit electrically connects with a first camera and a second camera, and the first camera is able to generate the first scene video signal, the second camera is able to generate the second scene video camera, respectively.

5. A device according to claim 1, wherein the video signal input unit is a screen, and this screen is able to switch to any one of the multiple projection devices for receiving its video signals.

6. A device according to claim 1, wherein a sequential interlaced scene separating device is connected for recovering the interlaced scene video signal back to the first scene video signal and the second scene video signal.

7. A device according to claim 1, wherein the frame rate of the interlaced scene video signal is higher than those of the first scene video signal and the second scene video signal.
